(19) United States
(12) Patent Application Publication
(10) Pub. No.: US 2013/0052417 A1
(43) Pub. Date: Feb. 28, 2013

(54) Rigid reinforced composite material and manufacturing method thereof

(71) Applicant: Sheng-Yu Tsai, Taipei (TW)

(72) Inventor: Sheng-Yu Tsai, Taipei (TW)

(21) Appl. No.: 13/596,646

(22) Filed: Aug. 28, 2012

Related U.S. Application Data
(60) Provisional application No. 61/529,611, filed on Aug. 31, 2011.

(51) Int. Cl. B29C 70/18; B32B 33/00; B05D 3/12

(52) U.S. Cl. 428/141; 264/101; 427/294

(57) ABSTRACT

A rigid reinforced composite material includes a plurality of first material layers. Each first material layer has a first texture. The first material layers are stacked, and the first textures are not all in parallel in the projection direction. In addition, a method of making the rigid reinforcing composite material is disclosed. Accordingly, the composite material having high rigidity and high strength can be fabricated by the simple and efficient manufacturing process, and the device using the composite material can be thinner and lighter.

### CROSS REFERENCE TO RELATED APPLICATIONS

The non-provisional patent application claims priority to U.S. provisional patent application Ser. No. 61/529,611 filed on Aug. 31, 2011. This and all other extrinsic materials discussed herein are incorporated by reference in their entirety.

### BACKGROUND OF THE INVENTION

1. Field of Invention

The disclosure relates to a composite material and a manufacturing method thereof, and in particular, to a rigid reinforced composite material and a manufacturing method thereof.

2. Related Art

The casing of electronic device is usually made of metal for being provided with high rigidity. In the recent years, portable electronic devices with thinness and lightness have become the most concerned issues.

Regarding to the manufacturing process, the plastic casing is usually fabricated by injection molding, which can almost form the desired structures by a single injection process. However, the strength of the plastic casing is insufficient, so the plastic casing is easily worn and broken. Besides, the surface of the plastic casing usually needs to be made by some decoration processes such as painting and coating. The metal casing is usually made by complex manufacturing processes, longer production time, and needs higher cost. In addition, since the metal casing is much heavy, it is hard to fit the requirements of thinness and lightness.

### SUMMARY OF THE INVENTION

A rigid reinforced composite material of this disclosure includes a plurality of first material layers, which are stacked. Each first material layer includes a first texture, and the first textures are not all in parallel in the projection direction.

A manufacturing method of a rigid reinforced composite material of the disclosure includes the following steps of: disposing a plurality of first material layers in a mold; vacuuming the mold; injecting a filling material into the mold; heating the mold to the solidification temperature of the filling material so as to solidify the filling material, thereby fixing the first material layers; and removing the mold to form the rigid reinforced composite material. Wherein, each first material layer includes a first texture, the first material layers are stacked, and the first textures are not all in parallel in the projection direction.

As mentioned above, the rigid reinforced composite material of the disclosure is composed of fiber materials with symmetric textures arrangement, so that it has high strength. In addition, the disclosure utilizes the fiber textures of the bamboo material so as to enhance the rigidity and includes more attractive appearance. Besides, the bamboo material includes the advantages of low cost, high rigidity, light, thin and environmental friendly.

In addition, this disclosure also applies different kinds of resins and filling materials in the manufacturing process, so that the fiber materials with specific arrangement can provide high strength and rigidity (elasticity coefficient). The fiber materials including various kinds of fibers, such as glass fiber or carbon fiber, can be formed by weaving process, thereby forming the fiber textures with desired strength, elasticity, and surface appearance. Accordingly, the composite material can be applied to fabricate the casing of various devices, so that the fabricated casing includes woven fiber texture and can thus provide specific touch sense and surface texture.

The conventional manufacturing method of the casing with woven fiber texture is to impregnate the woven fabric in a thermo-setting resin, and then to perform a thermocompressing process. For example, if the woven fabric is impregnated in epoxy, the surface of the woven fiber texture will form many holes and become non-planar after the high temperature of the thermo-compressing process.

Thus, it is necessary to perform additional repairing processes such as puttying, polishing, painting and the likes. The manufacturing method of the rigid reinforced composite material of the disclosure is to impregnate the fiber material and bamboo material and then to vacuum the materials so as to obtain the highly solidified material. The manufacturing method of the disclosure fabricates the desired rigid composite material with high rigidity, thinness, lightness, and beautiful appearance, so that the device manufactured with this composite material is thin and light and still has high strength.

### BRIEF DESCRIPTION OF THE DRAWINGS

FIG. 1A is a side view of a rigid reinforced composite material according to an embodiment of the disclosure;

FIG. 1B is an exploded view of the rigid reinforced composite material of FIG. 1A;

FIG. 2A is a side view of another rigid reinforced composite material according to the embodiment of the disclosure;

FIG. 2B is an exploded view of the rigid reinforced composite material of FIG. 2A;

FIG. 3A is a side view of another rigid reinforced composite material according to the embodiment of the disclosure;

FIG. 3B is an exploded view of the rigid reinforced composite material of FIG. 3A;

FIG. 4A is a side view of another rigid reinforced composite material according to the embodiment of the disclosure;

FIG. 4B is an exploded view of the rigid reinforced composite material of FIG. 4A; and

FIG. 5 is a flow chart of a manufacturing method of a rigid reinforced composite material according to the embodiment of the disclosure.

### DETAILED DESCRIPTION OF THE INVENTION

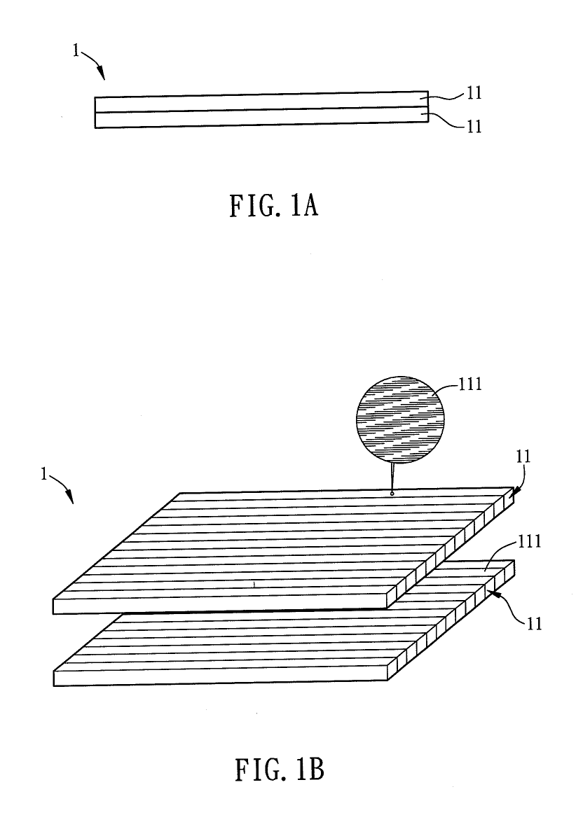

FIG. 1A is a side view of a rigid reinforced composite material 1 according to an embodiment of the disclosure, and FIG. 1B is an exploded view of the rigid reinforced composite material 1 of FIG. 1A. Referring to FIGS. 1A and 1B, the rigid reinforced composite material 1 includes two first material layers 11, which are stacked one by one. To be noted, the number of the first material layers 11 is not limited. In practice, the number of the first material layers can be increased depending on the applied environment factors and strength requirements. The structure features of the composite material 1 will be described hereinafter.

In this embodiment, the first material layer 11 is made of bamboo and includes a first texture 111. The first texture 111 is formed by the fiber structure inside the bamboo sheet of the first material layer 11, so that the first material layer 11 can evenly spread the force by the fibrillar first texture 111. In addition, since the bamboo material has high strength as well as lightness and thinness, the first material layer 11 made of multiple bamboo sheets can provide lateral support to the composite material 1. Thus, the composite material 1 includes good buckling ability and thus provides high pressure resistance.

The two first material layers 11 are combined by adhering and solidifying of a filling material (not shown). Herein, the filling material can be filled within the first material layers 11 by vacuum impregnating, and then fix the first material layers 11 by thermosetting so as to binding the first material layers 11. Compared with the conventional combining method with impregnating only, the vacuum impregnating with the proper filling material can more securely bind the first material layers 11. The manufacturing method of the rigid reinforced composite material 1 will be described hereinafter, so the detailed description will be omitted here.

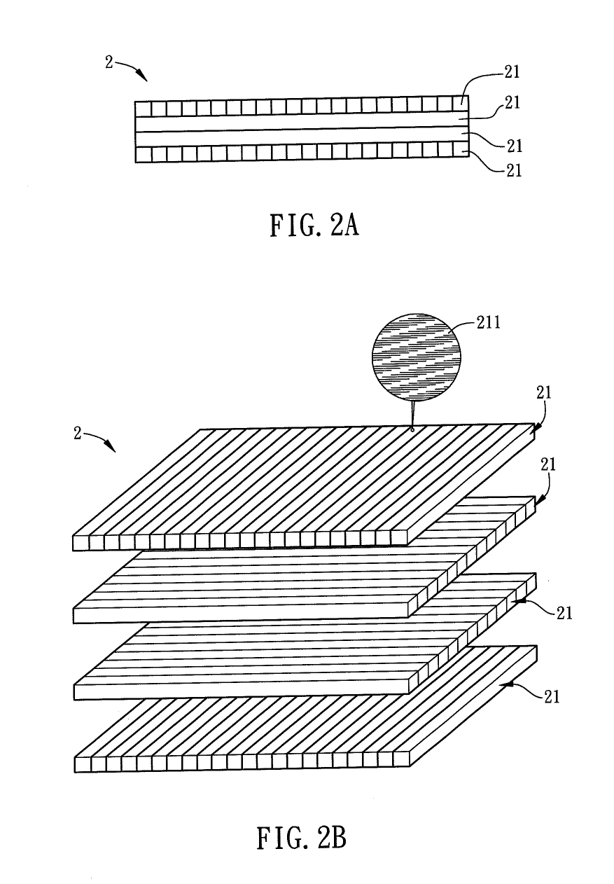

FIG. 2A is a side view of another rigid reinforced composite material 2 according to the embodiment of the disclosure, and FIG. 2B is an exploded view of the rigid reinforced composite material 2. Referring to FIGS. 2A and 2B, the structure and feature of the rigid reinforced composite material 2 are similar to the above-mentioned rigid reinforced composite material 1, and their difference is in that the rigid reinforced composite material 2 includes two more first material layers 21. That is, the rigid reinforced composite material 2 includes totally four first material layers 21.

The top and bottom first material layers 21 are disposed at two sides of the rigid reinforced composite material 1. The first textures of the top and bottom first material layers 21 are perpendicular to the textures of inner two first material layers 21 in the projection direction. This configuration can enhance the rigidity and strength of the rigid reinforced composite material 2. The residual functions of the rigid reinforced composite material 2 are similar to those of the above embodiment, so the detailed description thereof will be omitted.

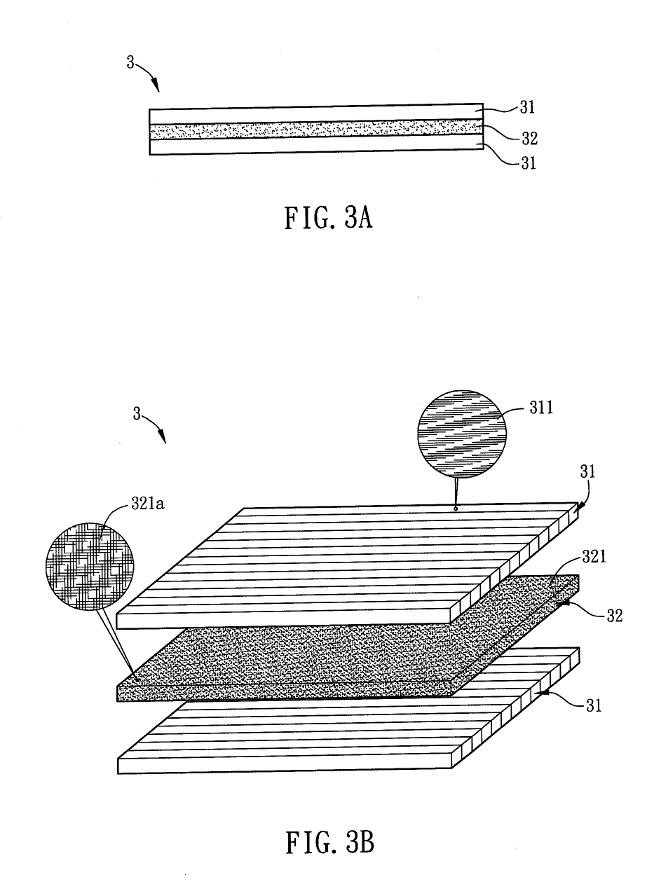

FIG. 3A is a side view of another rigid reinforced composite material 3 according to the embodiment of the disclosure, and FIG. 3B is an exploded view of the rigid reinforced composite material 3. Referring to FIGS. 3A and 3B, the structure and feature of the rigid reinforced composite material 3 are similar to the above-mentioned rigid reinforced composite material 1, and their difference is in that the rigid reinforced composite material 3 further includes at least one second material layers 32.

The two first material layers 31 are disposed at two sides of the second material layer 32 in parallel, and the directions of the two first material layers 31 are in symmetric. That is, the first textures 311 of the two first material layers 31 are symmetrically arranged, and are perpendicular to a second texture 321 of the second material layer 32. In the rigid reinforced composite material 3, the different layers include symmetrical fiber textures, so that the composite material 3 includes high rigidity and high strength. In other words, the symmetrical fiber texture arrangement can express a uniform mechanical strength (e.g. in thermal expansion property), so the rigid reinforced composite material 3 of this disclosure can be applied to the equipment requiring uniform surface materials.

To be noted, the numbers of the first material layers and the second material layers are not limited. In practice, six, eight or an even number of first material layers can be arranged according to the required strength, thickness and/or weight of the composite material.

In this embodiment, the second material layer 32 is made of fiber and/or net material and may include a plurality of microstructures 321a. In more specific, the second material layer 32 is formed by weaving fibers and/or net structures, thereby forming the second texture 321, wherein the gaps between the fibers and/or net structures are formed as the microstructures 321a.

In this embodiment, the second material layer 32 is made of carbon fibers. Of course, in other embodiments, the second material layer can be made of other fibers and/or net structures, which can be woven to form a material that has high rigidity and is easily processed. The available raw material includes, for example but not limited to, glass fibers, organic fibers or metal fibers. In addition, the second material layer 32 of this embodiment is formed by weaving a single fiber. In practice, the second material layer of this disclosure can also be formed by various kinds of fibers and/or net structures.

To be noted, the second material layer 32 can be a single-layer structure or a multilayer structure depending on the requirements of strength and design.

The second material layer 32 is mainly used as the reinforcement layer of the rigid reinforced composite material. The selected fiber material has the properties of lighter, tougher, higher strength and rigidity in unit weight, and better resistances to weather, corrosion and durability than metal materials. Besides, the fiber material has high degree of freedom in design of mechanical properties.

The second material layer 32 is disposed at two first material layers 31, and in particular, the second material layer 32 is disposed between two first material layers 31. In this embodiment, the first material layers 31 and the second material layer 32 are in thin plate structure, and their sizes are the same for facilitating the stacking and processing. However, these are not to limit the disclosure. For example, the shapes and sizes of the first and second material layers can be modified according to the applied product, environment and requirement. The bamboo material has good strength of fiber structure, lightness, thinness and environment friendly, and is suitable in decoration, and the rigid reinforced composite material 3 of this disclosure has at least an outer side configured with the first material layer 31 made of the bamboo material. Otherwise, if the decoration purpose is not necessary, the composite material does not need to match the above arrangement.

With reference to FIGS. 3A and 3B, after positioning the material layers, the first texture 311 and the second texture 321 are perpendicular to each other in the projection direction. In more detailed, the second texture 321 is formed by weaving the carbon fibers, so that the rigid reinforced composite material 3 of this disclosure can include high strength and good impact durability.

Similarly, the first material layers 31 and the second material layer 32 are combined by adhering and solidifying of a filling material (not shown). Herein, the filling material can be filled within the microstructures 321a of the second material layer 32 by vacuum impregnating, and then fix the first material layers 31 and the second material layer 32 by thermosetting so as to binding the first material layers 31 and the second material layer 32.

Compared with the conventional combining method with impregnating only, the vacuum impregnating with the proper filling material can more securely bind the first material layers 31 and the second material layer 32. The manufacturing method of the rigid reinforced composite material 3 will be described hereinafter, so the detailed description will be omitted here.

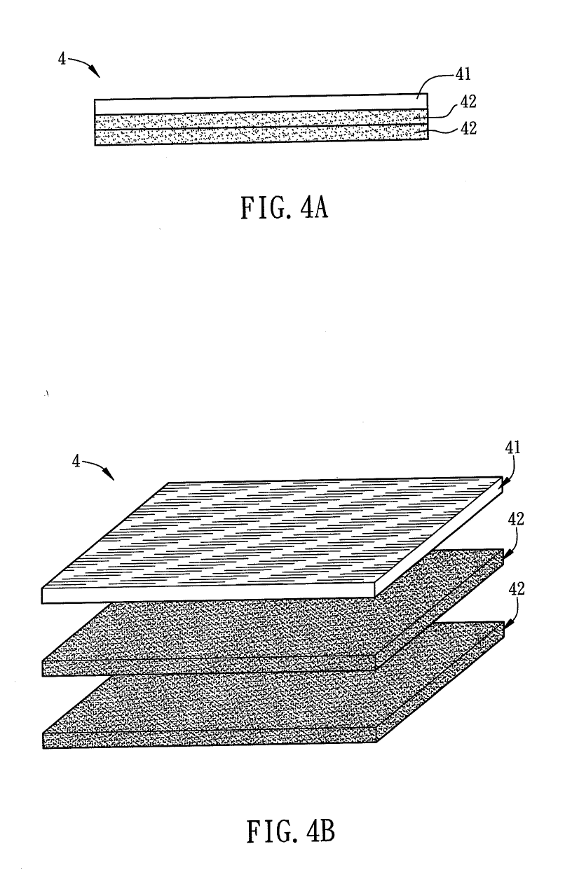

FIG. 4A is a side view of another rigid reinforced composite material 4 according to the embodiment of the disclosure, and FIG. 4B is an exploded view of the rigid reinforced composite material 4. Referring to FIGS. 4A and 4B, the structure and feature of the rigid reinforced composite material 4 are similar to the above-mentioned rigid reinforced composite material 3, and their difference is in that the rigid reinforced composite material 4 includes a first material layer 41 and two second material layers 42.

In other words, compared to the composite material 3, one of the first material layers is replaced by the second material layer. The two second material layers 42 can be formed by the same fiber material or different fiber materials. Any configuration that allows the layers of the composite material 4 include symmetrical fiber textures so as to achieve high rigidity and strength is acceptable. Since the composite material 4 includes one more second material layer 42, the strength of the composite material 4 can be improved. This configuration is not limited and the number of the second material layers can be increased depending on the actual needs.

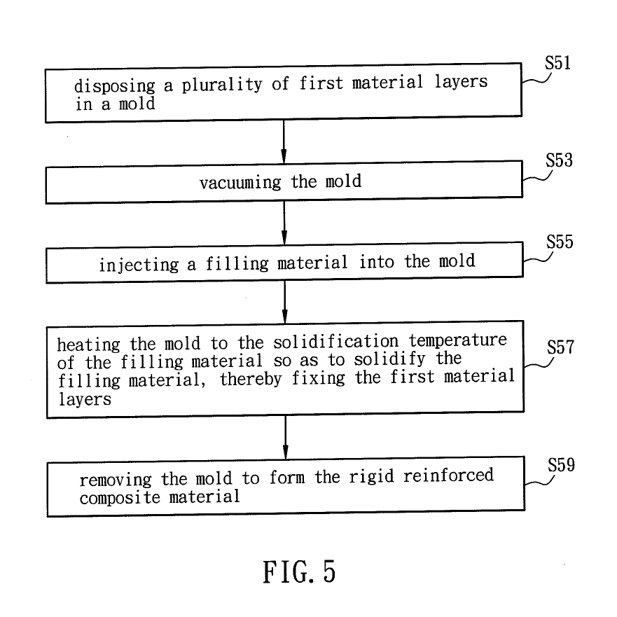

FIG. 5 is a flow chart of a manufacturing method of a rigid reinforced composite material according to the embodiment of the disclosure. As shown in FIG. 5, the manufacturing method of a rigid reinforced composite material includes the following steps of: disposing a plurality of first material layers in a mold (step S51); vacuuming the mold (step S53); injecting a filling material into the mold (step S55); heating the mold to the solidification temperature of the filling material so as to solidify the filling material, thereby fixing the first material layers (step S57); and removing the mold to form the rigid reinforced composite material (step S59). The structural features and operation steps of the above components are all disclosed hereinabove, so the detailed description will be omitted.

In order to make the details more comprehensive, the manufacturing method of a rigid reinforced composite material will be described in view of the above-mentioned embodiments. To be noted, the descriptions of the following examples are for illustrations only and are not to limit the scope of the disclosure.

Referring to FIGS. 1B and 5, in the step S51, a plurality of first material layers 11 are disposed in the cavity of a mold (not shown). Herein, the size of the cavity is larger than or equal to that of the first material layer 11.

In the step S53, the mold containing the first material layers 11 are enclosed (sealed) and then vacuumed. To be noted, this “vacuuming step” is not limited to the circumstance of totally air free and can include the theoretically acceptable tiny error caused by, for example, manufacturing defect, or occasional situations.

After the vacuuming step, the step S55 is to inject a filling material into the mold. In this embodiment, the filling material is, for example but not limited to, resin. In practice, the filling material can be selected from epoxy, unsaturated polyester resin, phenolic resin, acrylic resin, polyurethane resin, and the likes.

In more detailed, the step S55 is to provide vacuum to the mold so as to force the filling material to penetrate into the fiber structure of the first material layers 11.

Herein, the filling material fulfills the entire mold so that the filling material can sufficiently flow into and attach to the material layers. Since the step S55 utilizes the vacuum impregnating method to apply resin, it can prevent the air remaining in the gaps, thereby fully filling the filling material between the materials and in the gaps within the materials.

As a result, the resin can enter the materials so as to achieve the complete plasticization of the materials. The undesired bubbles can be formed by the remaining air or the volatile chemical material, such as the solvent of the resin precursor or the volatile component of the resin. Since the bubbles results in the stress concentration, the fiber close to the bubbles will lack the lateral support and thus be easily bent by stress. Fortunately, the manufacturing method of this disclosure can effectively remove the air between and inside the materials.

In this embodiment, it provides a pretreatment to apply a coating on the first material layers 11 before the step S51. In more specific, a formation machine is used to apply the coating on the first material layers 11. Herein, the coating is resin, which can be the same as the filling material such as epoxy, unsaturated polyester resin, phenolic resin, acrylic resin, polyurethane resin, or the likes.

The above-mentioned formation machine can be an extruder, roller, calender or the likes. Through the proper formation machine, the adhesive material such as resin can be evenly coated on the first material layers 11 in advance, so that the surface of each first material layer 11 can be coated with resin. This configuration can slightly bind the first material layers 11 so as to facilitate the following vacuum impregnating and thermosetting processes, thereby reducing the total processing time.

To be noted, in practice, when the rigid reinforced composite material includes the second material layer, the first and second material layers can be processed by the same way as mentioned above. Since the detailed steps of the manufacturing method of the rigid reinforced composite material have been described hereinabove, the descriptions thereof will be omitted here.

Besides, when this disclosure is applied to a common electronic device (e.g. a casing), which needs a special designed and fashion appearance, it can be achieved by a simply plate thermocompressing process. Since the disclosure does not need the conventional injection molding process, the manufacturing processes become simpler. Besides, the products of the disclosure further include the advantages of high rigidity, high strength, lightness and thinness.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A rigid reinforced composite material, comprising:
a plurality of first material layers, wherein each of the first material layers has a first texture, the first material layers are stacked, and the first textures are not all in parallel in the projection direction.

2. The composite material of claim 1, wherein the first material layers are made of bamboo.

3. The composite material of claim 1, further comprises a filling material disposed between the first material layers.

4. The composite material of claim 3, wherein the filling material comprises epoxy, unsaturated polyester resin, phenolic resin, acrylic resin, polyurethane resin, or their combinations.

5. The composite material of claim 1, further comprises at least a second material layer disposed at the first material layer.

6. The composite material of claim 5, wherein the second material layer comprises fiber and/or net material.

7. The composite material of claim 6, wherein the second material layer comprises carbon fiber, glass fiber, organic fiber, or metal net.

8. The composite material of claim 7, wherein the second material layer is made by weaving a single fiber or multiple fibers.

9. The composite material of claim 1, wherein the first material layers are symmetrically disposed at two sides of the second material layer.

10. A manufacturing method of a rigid reinforced composite material, comprising the steps of:
disposing a plurality of first material layers in a mold, wherein each of the first material layers has a first texture, the first material layers are stacked, and the first textures are not all in parallel in the projection direction;
vacuuming the mold;
injecting a filling material into the mold;
heating the mold to the solidification temperature of the filling material so as to solidify the filling material, thereby fixing the first material layers; and
removing the mold to form the rigid reinforced composite material.

11. The manufacturing method of claim 10, wherein the first material layers are made of bamboo.

12. The manufacturing method of claim 10, wherein the filling material is disposed between the first material layers.

13. The manufacturing method of claim 10, wherein the filling material comprises epoxy, unsaturated polyester resin, phenolic resin, acrylic resin, polyurethane resin, or their combinations.

14. The manufacturing method of claim 10, wherein the composite material further comprises:
at least a second material layer disposed at the first material layer.

15. The manufacturing method of claim 14, wherein the second material layer comprises fiber and/or net material.

16. The manufacturing method of claim 15, wherein the second material layer comprises carbon fiber, glass fiber, organic fiber, metal net, or their combinations.

17. The manufacturing method of claim 16, wherein the second material layer is made by weaving a single fiber or multiple fibers.

18. The manufacturing method of claim 16, wherein the first material layers are symmetrically disposed at two sides of the second material layer.

19. The manufacturing method of claim 10, further comprising the step of
applying a coating on the first material layers.

20. The manufacturing method of claim 19, wherein the coating comprises epoxy, unsaturated polyester resin, phenolic resin, acrylic resin, polyurethane resin, or their combinations.
